(19) United States
(12) Patent Application Publication
(10) Pub. No.: US 2005/0025888 A1
(43) Pub. Date: Feb. 3, 2005

(54) Method for shielding articles on a coating line

(75) Inventor: James Dunman, Conowingo, MD (US)

Correspondence Address: VENABLE, BAETJER, HOWARD AND CIVILETTI, LLP, P.O. BOX 34385, WASHINGTON, DC, 20043-9998, US

(73) Assignee: Graham Packaging, Inc., York, PA (US)

(21) Appl. No.: 10/630,982

(22) Filed: Jul. 31, 2003

(51) Int. Cl. B05D 5/00

(52) U.S. Cl. 427/282

(57) ABSTRACT

The finish of plastic containers being coated with another plastic in a spray coating line is protected by shields made from a material that accumulates the sprayed coating material only slowly. The slowed accumulation increases the time intervals between required maintenance for the shields to at least as long as the intervals between other required maintenance for the spray coating line. As a result, downtime of the line just for replacement of the shields is eliminated. In addition, the shields are made from scraps of the material used to make the bottles. The shields are made by injection molding them with dimensions that take into account the inherent shrinkage of the material during cooling after removal from the mold, so that, after shrinkage, the shields fit onto the conveyor chain bottle chucks with a friction fit.

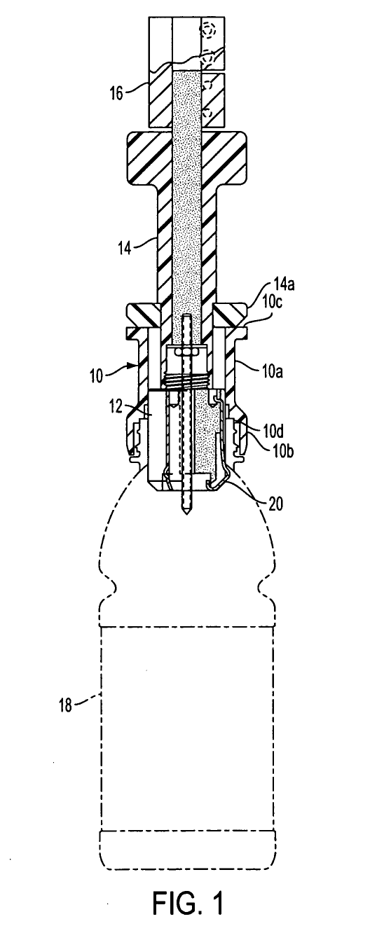

### BACKGROUND OF THE INVENTION

The present invention relates to a method for shielding articles on a coating line and, more particularly, to a method for preventing a portion of each article from being coated.

Plastic containers, for example, plastic bottles, are not entirely resistant to the penetration of oxygen through their walls. As a result, the contents of the containers can be adversely affected over time by the migration of oxygen through the container walls. Therefore, containers that are made of a first plastic, for example, PET (polyethylene terephthalate), are electrostatically spray coated with a thin layer of a different, barrier plastic that acts as a barrier to oxygen. Any application of the coating on the threads or other finish of the containers would interfere with the capping and cause a delamination from the underlying PET.

Typically, the containers hang from supporting chucks on a conveyor chain and are moved through a coating spraying station. Shields for protecting the threads from the coating are currently being used, but these shields are machined from nylon at a current cost of approximately $10 each. Nylon is used because it can withstand the heat associated with the conveyor line during the coating curing process, which reaches about 170° F. Due to the buildup of the coating plastic, the sprayed coating must be removed from the shields, a very labor intensive process. The conveyor line is shut down once a week for other maintenance, but the nylon shields must be cleaned approximately every five days, thus resulting in additional shutdowns of the line. There are thousands of shields, for example, 6000 shields, on each conveyor line. Despite the cleaning, hundreds, for example, 500-700, of these shields must be replaced each month.

### SUMMARY OF THE INVENTION

By the present invention, the shields are made by injection molding them with dimensions that take into account the inherent shrinkage of the material during cooling after removal from the mold, so that, after shrinkage, the shields fit onto the conveyor chain container chucks with a friction fit. Furthermore, the shields are made from a material that slows the accumulation of the sprayed coating material. Moreover, the slowed accumulation of the coating material on the shields increases the time intervals between required maintenance for the shields, so that those intervals are at least as long as the intervals between other required maintenance for the spray coating line. As a result, downtime of the line just for replacement of the shields is eliminated. At the increased intervals, the shields are simply pulled off the chucks, disposed of and replaced. There is no need for cleaning the coating buildup from them. In addition, the shields are made from scraps of the material used to make the containers.

### BRIEF DESCRIPTION OF THE DRAWING

The FIGURE is a vertical cross section of a shield according to the present invention in place on a container supporting chuck on a conveyor of a container spray coating line.

### DETAILED DESCRIPTION OF THE PREFERRED EMBODIMENT

As can be seen from the drawing FIGURE, a shield according to the present invention, which is designated generally by the reference numeral 10, is held by a friction fit on a chuck 12, which is part of a support assembly 14 depending from a conveyor chain 16 of a spray coating line. The shield 10 is generally cylindrical, having an upper portion 10a with an internal diameter that fits on the chuck 12 with a friction fit and a lower portion 10b with an internal diameter large enough to receive the finish of a container 18, for example, a bottle and an axial dimension sufficient to cover the finish. An upper end 10c of the shield 10 engages an enlarged portion 14a of the support assembly 14, and a shoulder 10d at the junction of the upper portion 10a and the lower portion 10b engages the top of the container 18.

A large plurality, for example, hundreds, of the support assemblies 14 and chucks 12 are connected to the conveyor chain 16. Each chuck 12 carries the container 18 through a spray coating station, at the end of which the container 18 is removed from the chuck 12 so that a new container can be placed on the chuck as the conveyor chain 16 continues to move. Typically, the container remains attached to the chuck throughout a curing process before the container is removed. The chuck 12 has a plurality of springs 20, which retain the container releasably, but securely. Plastics commonly used for containers are not entirely impervious to the migration of oxygen through them. As a result, a coating of a barrier plastic is sprayed onto the container at the spray station. One suitable barrier plastic is available commercially under the name Bairocade®, a registered trademark of PPG Industries, Inc.

The shields 10 are injection molded of a plastic with dimensions such that, after the shields are removed from the mold and allowed to cool, the cooled shields have an internal diameter that engages the outer diameter of the chucks 12 in a friction fit. Thus, the shields 10 can quickly be pushed onto the chucks 12. The plastic shields 10 inherently shrink upon cooling after removal from the mold.

In the spray station, the spray coating is applied to the containers in a known manner, such as electrostatically. In such an operation, an electrostatic charge is applied to the containers and a charge of opposite polarity is applied to the spray, so that the spray is attracted to the containers 18. The electrostatic charge applied to the containers also finds it way to the shields 10. The shields 10 are made of the same plastic as the containers, which, in the preferred embodiment, is PET (polyethylene terephthalate). The present inventor has found that the barrier plastic being sprayed builds up more slowly on the material of the containers than on nylon, which was previously used for the shields.

Furthermore, according to the present invention, the containers are made in the same place where they are coated. The making of the containers inherently produces scrap material. By the present invention, the shields are made from scrap material produced in the making of the containers.

Spray coating lines involve routine maintenance. More specifically, lubrication and other maintenance must be performed weekly. The spray coating builds up slowly enough on the shields 10 according to the present invention that no cleaning or removal of the shields is required more frequently than weekly. In fact, it has been found that the spray coating builds up slowly enough that the shields can go two weeks without being changed. As a result, there is no need to shut down the spray coating line merely to clean or remove the shields 10. Instead, the spray coating line need only be shut down at the intervals required to perform other necessary maintenance.

It will be apparent to those skilled in the art and it is contemplated that variations and/or changes in the embodiments illustrated and described herein may be made without departure from the present invention. Accordingly, it is intended that the foregoing description is illustrative only, not limiting, and that the true spirit and scope of the present invention will be determined by the appended claims.

1. A method of protecting portions of containers from being coated while other portions of the containers are being coated, comprising:
making containers from a first material;
coating the containers with a second material; and
prior to coating, covering portions of the containers to remain uncoated with shields of the first material,
wherein the shields are made from scraps of the first material produced from the making of the containers.

2. The method of claim 1, wherein the containers are bottles.

3. The method of claim 2, wherein the portions of the bottles to be protected from coating are the portions of the bottles that will contact bottle closures.

4. The method of claim 1, wherein the first material is polyethylene terephthalate.

5. The method of claim 1, wherein the second material can cure to form an oxygen barrier.

6. The method of claim 1, further comprising making the shields by injection molding.

7. The method of claim 1, wherein the shields contact the containers, and the containers are electrostatically charged to attract the second material.

8. The method of claim 1, wherein the containers are coated with the second material by spraying.

9. The method of claim 1, wherein the containers are releasably supported on a conveyor during coating and removed from the conveyor after coating, and the shields are connected to the conveyor during and after the coating.

10. The method of claim 9, wherein shields are removably held on the conveyor by a friction fit.

11. The method of claim 10, wherein the conveyor is shut down periodically for maintenance, and the shields are removed from the conveyor and disposed of during the shutdown.

12. The method of claim 11, wherein the conveyor is shut down for maintenance every approximately 7 days.

13. A method of protecting portions of containers from being coated while other portions of the containers are being coated, comprising:
making containers from a first material;
coating the containers with a second material;
prior to coating, covering portions of the containers to remain uncoated with shields of the first material,
wherein the shields contact the containers, the containers are electrostatically charged to attract the second material, and the containers are made from polyethylene terephthalate.

14. The method of claim 13, wherein containers are coated with the second material by spraying.

15. A method of protecting portions of containers from being coated while other portions of the containers are being coated, comprising:
making containers from a first material;
coating the containers with a second material;
prior to coating, covering portions of the containers to remain uncoated with shields of the first material,
wherein the containers are releasably supported on a conveyor during coating and removed from the conveyor after coating, the shields are connected to the conveyor during and after the coating, and the shields are removably held on the conveyor by a friction fit.

16. A method of protecting portions of containers from being coated while other portions of the containers are being coated, comprising:
making containers from a first material;
coating the containers with a second material;
prior to coating, covering portions of the containers to remain uncoated with shields of the first material,
wherein the containers are releasably supported on a conveyor during coating and removed from the conveyor after coating, the shields are connected to the conveyor during and after the coating, the conveyor is shut down periodically for maintenance, and the shields are removed from the conveyor and disposed of during the shutdown.
